(19) United States
(12) Patent Application Publication
(10) Pub. No.: US 2007/0240316 A1
(43) Pub. Date: Oct. 18, 2007

(54) Cutter

(76) Inventors: Fu-Lai Yu, San Hsia Town (TW); Chin-Tien Huang, San Hsia Town (TW)

Correspondence Address: OLSON & HIERL, LTD., 20 NORTH WACKER DRIVE, 36TH FLOOR, CHICAGO, IL, 60606, US

(21) Appl. No.: 11/402,683

(22) Filed: Apr. 12, 2006

(51) Int. Cl. B26B 13/00

(52) U.S. Cl. 30/254

(57) ABSTRACT

An improved cutter for minimizing deflection of the scissor blades during the cutting of a rigid slat, in particular the slats of a Venetian blind. The cutter includes a first scissor and a second scissor pivotally joined to each other at a fulcrum. The scissors further include blade portions suitable for cutting a slat when the scissors are closed. An engagement member is located at the distal end of each scissor. The engagement members are adapted to cooperatively engage one another as the jaw members are closing so that the engagement member of the second scissor is on top of the engagement member of the first scissor.

### FIELD OF INVENTION

This invention relates to an improved cutter for a slat, especially a slat of a Venetian blind. In particular, this invention relates to a cutter comprising a pair of scissors, each scissor having an engagement member that cooperatively engages its opposite engagement member when the scissors are closing.

### BACKGROUND OF INVENTION

Venetian blinds are a well known covering for windows. A Venetian blind contains a number of light blocking sections in the form of slats that are designed to extend horizontally across the width of the window space. One such example of a window shade is a Venetian blind, where the light blocking sections are made of aluminum or polyvinyl chloride slats.

While window spaces are built in a myriad of different widths, Venetian blinds are typically manufactured in a number of standard widths to achieve economies of scale. To accommodate a specific window space, a standard Venetian blind must be trimmed to the particular desired width.

One way of trimming Venetian blinds is to use a scissors-style cutter adapted for cutting the slats of the Venetian blind, such as the type disclosed in U.S. Pat. No. 4,876,795. When existing cutters are used to cut slats made of particularly rigid materials such as aluminum alloys, substantial resistance is presented to the scissor blades. Since the blades are joined only at the fulcrum, this has a tendency to cause the blades to deflect outward and separate from their normal contacting engagement. Instead of cutting through the slat, the blades may slip over and bend the slat, which can cause the blades to scratch or otherwise damage the surface of the slat. This deflection makes it difficult to cleanly trim the rigid slat and results in an unsightly end product.

What is needed is an improved cutter that efficiently and cleanly trims window shades, particularly rigid slats in a Venetian blind, while minimizing any deflection of the scissoring blades by the rigid slat. The present invention meets these desires and overcomes the shortcomings of the prior art.

### SUMMARY OF THE INVENTION

The present invention is an improved cutter for trimming slats, in particular for cutting the slats of a Venetian blind.

The cutter includes a pair of scissors comprising a first scissor and a second scissor pivotally joined to each other at a fulcrum. The scissors each have a jaw member portion distal to the fulcrum and a handle proximal to the fulcrum. At least one or both of the jaw members includes a blade portion that is suitable for cutting a slat as the jaw members are closing. Located at the distal end of each jaw member is an engagement member. The engagement members are adapted to cooperatively engage one another as the jaw members are closing in such a way that the engagement member of the second scissor overlaps, superimposes, or is on top of the engagement member of the first scissor to reduce deflection of the scissor blades relative to the cutting plane during the cutting of a rigid slat.

The present invention contemplates a number of engagement member configurations such as a projecting flange on one jaw member that overlaps with the distal end of the opposite jaw member, overlapping projecting flanges, or a tab and slot combination.

The improved cutter of the present invention creates a tight contact at the distal end of the cutter and consequently ensures close contact along the length of the cutting edges to reduce deflection and uneven cutting from slippage of the components during the cutting procedure.

### BRIEF DESCRIPTION OF THE DRAWINGS

In the drawings,

FIG. 1 is a perspective view of an embodiment of the improved cutter in accordance with the present invention;

FIG. 2 is a perspective view of the improved cutter of FIG. 1 in the closed position;

FIG. 2A is an enlargement of a portion of the improved cutter of FIG. 2 in the closed position;

FIG. 3 is a perspective view of an alternate embodiment of the improved cutter in accordance with the present invention;

FIG. 4 is a perspective view of the improved cutter of FIG. 3 in the closed position;

FIG. 4A is an enlargement of a portion of the improved cutter of FIG. 3 in the closed position;

FIG. 5 is a perspective view of another alternate embodiment of the improved cutter in accordance with the present invention;

FIG. 6 is a perspective view of the improved cutter of FIG. 5 in the closed position; and

FIG. 6A is an enlargement of a portion of the improved cutter of FIG. 5 in the closed position.

### DESCRIPTION OF PREFERRED EMBODIMENT

The invention disclosed herein is susceptible to embodiment in many different forms. The embodiments shown in the drawings and described in detail below are only for illustrative purposes. The disclosure is intended as an exemplification of the principles and features of the invention, but does not limit the invention to the illustrated embodiments.

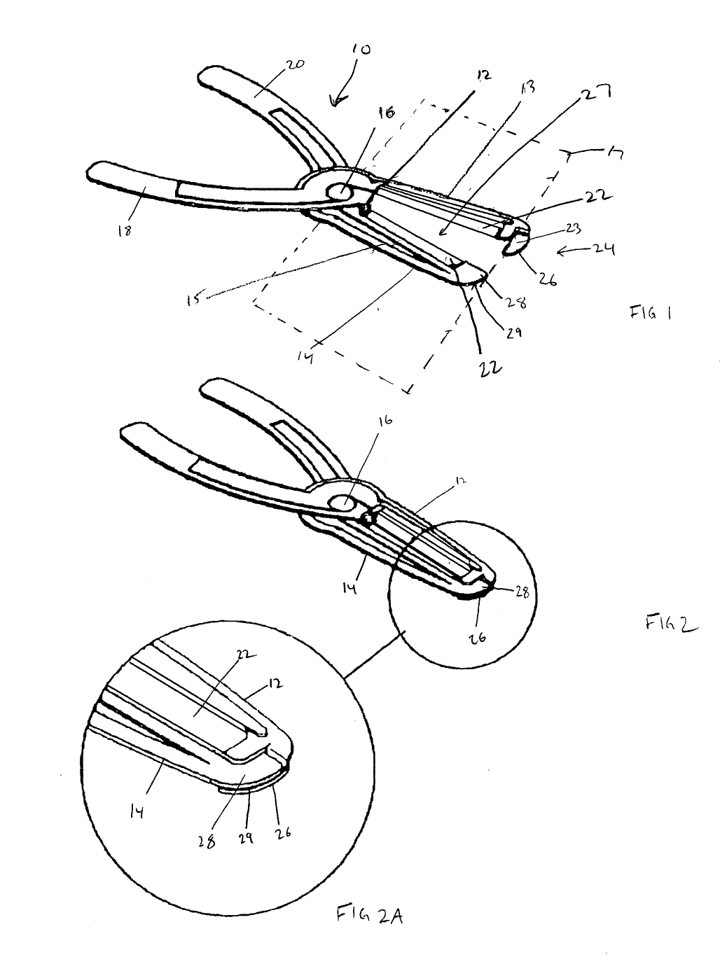

Referring to FIGS. 1 and 2, an embodiment of the improved cutter 10 according to the present invention is shown. The cutter comprises a pair of scissors 12 and 14 that are pivotally joined together by a pin, bolt, or rivet at a fulcrum 16. First scissor 12 and second scissor 14 also include jaw members 13 and 15 distal to the fulcrum 16 and handles 18 and 20 proximal to fulcrum 16. Scissors 12 and 14 thus open and close the gap 27 between jaw members 13 and 15 along cutting plane 17 by pivoting about fulcrum 16 when handles 18 and 20 are moved relative to each other.

Scissors 12 and 14 of cutter 10 each have a cutting edge 22 for cutting the slat. The length of the cutting edge 22 preferably is at least as long as the standard width of the Venetian blind slat to be cut.

At the distal end 24 of the jaw members 13 and 15 is a first scissor engagement member 26 on first scissor 12 and a second scissor engagement member 28 on second scissor 14. Together, the two engagement members 26 and 28 form an engagement structure for minimizing deflection of the scissors during cutting. Engagement members 26 and 28 are adapted to cooperatively engage each other as they are closing the gap 27. As more clearly shown in FIGS. 2 and 2A, the engagement member 28 located on the second scissor 14 overlaps or superimposes on top of and otherwise cooperates with the engagement member 26 located on the first scissor 12 as the scissors are closing. More preferably, the engagement members engage before the blade portions 22 engage the slat to be cut.

In the embodiment shown in FIGS. 1 and 2, the engagement member 26 is a projecting flange on the first scissor 12. The flange 26 extends towards gap 27 and defines an abutting surface 23. The flange 26 is offset so as to fit under the engagement member 28 on the second scissor 14 when the jaw members 13 and 15 are closing. This overlap occurs approximately when the jaw members 13 and 15 half close the gap 27. Preferably, the length of the flange 26 is set so as to permit abutting surfaces 23 and 29 to overlap approximately when the resistance to cutting is maximal.

FIGS. 2 and 2A illustrate a position where the jaw members 13 and 15 are completely closed and the abutting surface 23 of the flange 26 substantially lies adjacent and under to the abutting surface 29 of the second scissor engagement member 28. As the jaw members 13 and 15 close on a rigid slat (not shown), there is a tendency for jaw member 13 to be deflected relative to jaw member 15 and out of cutting plane 17. This is counteracted by flange 26 sliding under the second engagement member 28 as the scissors are closing. By reversing the relative positions of the engagement members to their respective scissors, i.e. the engagement member of the second scissor engages on top of the engagement member the first scissor as the first jaw member overlaps second jaw member, a tight contact can be maintained along the entire length of the blade portion to reduce deflection out of the cutting plane as the scissors close. Any deflection of jaw members 13 and 15 out of the cutting plane 17 during cutting is thus prevented by a locking abutment between the abutting surface 23 of the flange 26 and the abutting surface 29 of second engagement member 28.

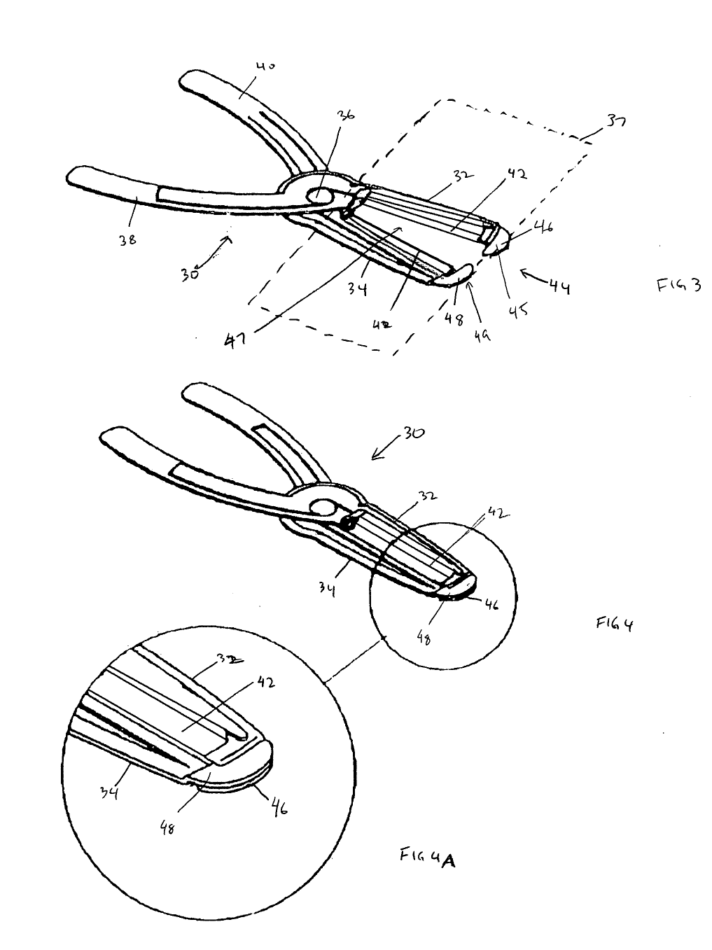

FIGS. 3, 4 and 4A show an alternate embodiment using a different engagement structure configuration. Cutter 30 has a first scissor 32 and a second scissor 34 that are pivotably joined at a fulcrum 36. Handles 38 and 40 are attached or are integral to scissors 32 and 34. First scissor 32 further has a blade portion 42 that cooperates in meeting engagement with blade portion 42 on second scissor 34. Cutting is accomplished by the sharp blade portions 42 closing the gap 47 along cutting plane 37.

In this embodiment, scissors 32 and 34 are provided with projecting flanges 46 and 48 at a distal end 44. Each of the flanges 46 and 48 project towards the gap 47. The flanges 46 and 48 are offset relative to each other and have abutting surfaces 45 and 49. As the scissors 32 and 34 are moved to close the gap 47 during cutting, the flanges 46 and 48 slide over each other so that the abutting surface 45 is overlapped by the abutting surface 49. In other words, the flange 48 of the second scissor 34 overlaps on top of the flange 46 on the first scissor 32. The flanges 46 and 48 thereby block any deflection of scissors 32 and 34.

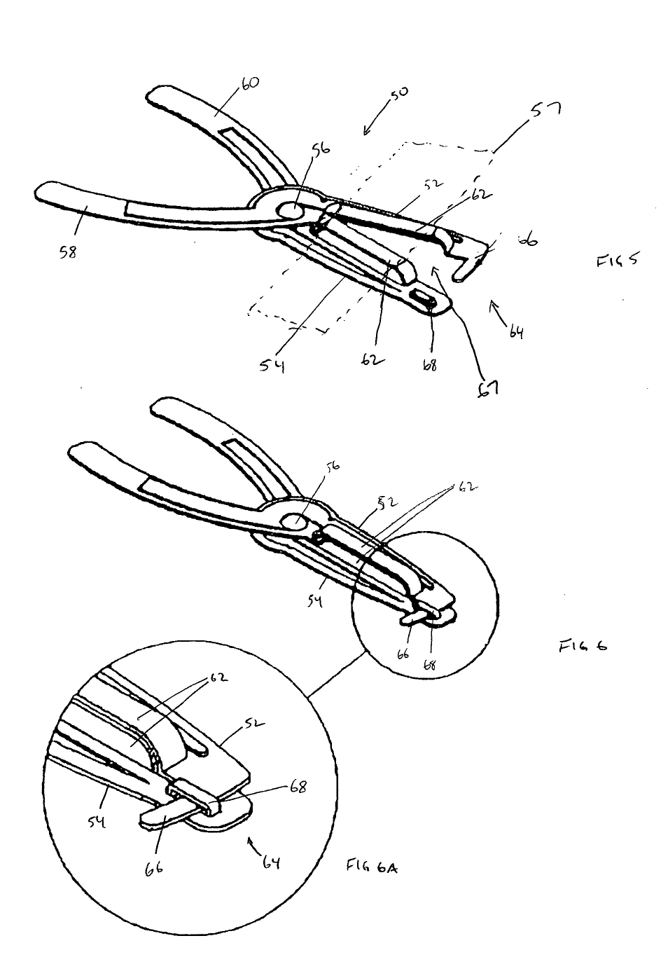

FIGS. 5, 6, and 6A illustrate another embodiment of the engagement members according to the invention. As in the previous embodiment, a cutter 50 includes a first scissor 52 and a second scissor 54 with handles 58 and 60 respectively. The two scissors 52 and 54 are pivotally joined together at a fulcrum 56. Scissors 52 and 54 each include a blade portion 62 curved to define a curved cutting section in the slat. The curvature of the blades can be made by means of pressing, punching, and other suitable procedures. A curved blade cutter may be used in conjunction with a guide block such as the one disclosed in U.S. Pat. No. 4,876,795 to Huang Chun-Cheng filed on Jul. 28, 1988, the contents of which are hereby incorporated by reference in their entirety.

As illustrated in FIGS. 5, 6 and 6A, a distal end 64 of the scissor 52 includes a tab 66 extending towards the gap 67. Tab 66 cooperates with and fits into a slot 68 on the scissor 54 as the cutter is closing. This engagement structure of tab 66 and slot 68 prevents deflection of the scissors 52 and 54 and maintains the cutting edges of the blade portions 62 in the cutting plane 57 while a slat is being cut.

Therefore, an improved cutter according to this invention provides an engagement structure at an end of the scissors that can lock and prevent deflection of the scissor blades out of the cutting plane. In a pair of conventional scissors, the scissor blades are kept in the cutting plane by virtue of the pivoting connection at the fulcrum. When a conventional scissor is used to cut a rigid object such as a slat, cutting may be inhibited by a deflection of the scissors slipping out of the cutting plane.

The cutter of the present invention alleviates this problem by creating an abutting contact between the scissors at the distal end of the cutter. This is accomplished by engaging the engagement member of the first scissor under the engagement member of the second scissor. By reversing the relative engagement of the engagement members relative to the scissor blades, i.e. the superimposing or overlapping the second scissor engagement member above the first scissor engagement member, an abutting contact is created between the first and second scissor blades. The cutter of the present invention thus prevents deflection of the blades out of the cutting plane by abutting the blade portion of the scissors at the distal end of the fulcrum.

Preferably, the engagement members engage to create this contact before the slat is cut or completely cut. More preferably, the engagement members are structured to engage each other as the scissors close and before the slat is cut. Depending on the thickness of the slats to be cut and the length of the scissor blades, the length of the projecting engagement members may vary. As an illustrative example, cutting a slat with a thickness of 2 mm with a pair of scissor blades 80 mm long may require that the engagement members project at least 8 mm along the cutting plane if the slat is initially placed 20 mm distal from the fulcrum. Similarly, cutting a thicker slat of 4 mm with the same cutter requires that the engagement member configuration span the 16 mm gap between blades at the distal end as the blades make contact with the slat when closing. It will be readily appreciated that different slat and blade length dimensions will change the distance that the engagement members must span at the distal end of the cutters in order to engage before the blades engage the slat.

The foregoing description and the drawings are illustrative of the present invention and are not to be taken as limiting. Other arrangements of the engagement structure may be implemented. For example, the engagement structure may be placed at locations other than at the tip or distal end of the scissors, such as on a portion of the scissors close to the pivotal fulcrum. The engagement structure may also be configured so that the first and second abutting surfaces overlap each other permanently. Such variations and modifications of part and embodiments are thus possible within the spirit and the scope of the present invention and will be readily apparent to those skilled in the art in view of the scope of the invention as claimed herein.

What is claimed is:

1. A cutter suitable for cutting a shade slat, the cutter comprising:
a pair of scissors comprising a first scissor and a second scissor pivotally joined at a fulcrum, each scissor having a jaw member extending distally of the fulcrum and a handle extending proximally from the fulcrum, the jaw members each having a blade portion cooperating with each other to cut the slat along a cutting plane;
one jaw member having a first engagement member for complementarily engaging a second engagement member on the opposite jaw member, the engagement members adapted to cooperatively engage one another so that the engagement member on the second scissor cooperatively engages the engagement member of the first scissor when the jaw members are closing.

2. The cutter of claim 1, wherein the first engagement member is a flange.

3. The cutter of claim 2, wherein the second engagement member is a flange offset from the flange of the first engagement member.

4. The cutter of claim 2, wherein the second engagement member is a slot for receiving the flange of the first engagement member.

5. The cutter of claim 1, wherein the inner portion of each jaw member is partially deflected to form a knife blade offset and substantially parallel to the plane of the jaw member.

6. A cutter suitable for cutting a shade slat, the cutter comprising:
a first scissor and a second scissor pivotally joined together along a cutting plane, wherein the first scissor includes a first blade and the second scissor includes a second blade, the first and second scissors defining a gap therebetween; and
an engagement structure provided at an end proximate to the first and second blades, wherein the engagement structure includes at least a flange projecting from the first scissor towards the gap, the flange further having a first abutting surface configured to engage with a second abutting surface on the second scissor.

7. The cutter of claim 6, wherein the first and second abutting surfaces are configured to engage each other as the first and second blades are closing the gap.

8. The cutter of claim 7, wherein the first and second abutting surfaces engage each other when the first and second blades half close the gap.

9. The cutter of claim 6, wherein the engagement structure is formed at a tip of the first and second scissors.

10. The cutter of claim 6, wherein the engagement structure includes a slot on the second scissor configured to receive the engagement of the flange.

11. The cutter of claim 6, wherein the first abutting surface is oriented on a side of the first scissor opposite the side of the second scissor, and the second abutting surface is oriented on a side of the second scissor opposite the side of the first scissor.

12. A method for using a cutter with a first scissor and a second scissor for cutting a slat, and especially a slat of a Venetian blind, comprising:
inserting the slat between a pair of scissor blades;
closing the scissor blades around the slat;
engaging an opposing pair of engagement members at the distal end of the scissors so that the engagement member on the second scissor overlappingly engages on top of the engagement member of the first scissor;
cutting the slat.

13. The method of claim 12 whereby the opposing engagement members engage before the scissor blades contact the slat.
